(19) United States
(12) Patent Application Publication
(10) Pub. No.: US 2011/0313970 A1
(43) Pub. Date: Dec. 22, 2011

(54) Method and device for resource management and recording medium for said method

(75) Inventors: Guillaume Dorbes, Nozay (FR); Cyril Hue, Les Moulineaux (FR); Claire Bazin, Paris (FR)

(73) Assignee: Alcatel Lucent 3, Paris (FR)

(21) Appl. No.: 12/926,268

(22) Filed: Nov. 5, 2010

Related U.S. Application Data
(63) Continuation of application No. PCT/FR2009/050901, filed on May 14, 2009.

(30) Foreign Application Priority Data
May 15, 2008 (FR) 0802626

(51) Int. Cl. G06F 7/00

(52) U.S. Cl. 707/609; 707/E17.005

(57) ABSTRACT

The resource management method of the present invention includes:
storing (90) an instantiable model of a card intended to contain a resource description, said card model, during the instantiation thereof to create a new card, forcing the acquisition of:
   a card identifier,
   at least one access path containing an address, and
   a reference domain for each access path, the reference domain specifying, if the resource is an address, which computer application to execute from among a plurality of applications capable of being specified by the reference domain to contact the person corresponding to said address or to access the information corresponding to said address.

The invention relates to a method and device for managing resources and a recording medium for implementing this method.

The resources here are executable files stored in a memory of an electronic calculator or addresses enabling a computer application to contact a person or access a piece of information.

Management method refers to a method which makes it possible to classify and sort these resources based on predetermined criteria in order to enable a user to easily find one of these resources. For example, the resource management methods particularly make it possible to order and filter the resources based on predetermined criteria.

There are methods for managing people's addresses. These methods are also known as address book management methods For example, such a method exists within the application known as Microsoft® Outlook. The entries (“cards”) within this address book are designed to contain various possible addresses of a contact, such as his or her telephone numbers, e-mail addresses, and mailing address. This card is recorded in a format specific to the application which is to use it. Thus, for example, whenever a user wishes to send an e-mail to a contact which he or she has selected within his or her address book, only the Outlook application can make use of the card's content in order to perform this task.

There are also many other methods for managing other resources. For example, Internet browsers can be used to manage addresses leading to web or HTML (Hyper Text Markup Language) pages. These methods are better known by the term bookmark management. Other applications make it possible to manage image, audio, or video files. However, these various management methods are incompatible with one another. For example, an address book's management method cannot also manage shortcuts to webpages, images, or audio or video files.

It is, however, desirable to have a method for managing resources that makes it possible to manage different types of resources, regardless of the computer application to be executed in order to use those resources.

The invention aims to satisfy this desire. Its object is therefore a resource management method including the saving, within a memory of an electronic calculator, of an instantiable model of a card intended to contain a description of a resource, said card model requiring, when it is instantiated to create a new card, the acquisition of
a card identifier used to identify this card from among the set of all cards already created,
at least one access path containing the address in the event that the resource is an address and, an access path in the event that the resource is an executable file, and
a reference domain for each access path, the reference domain specifying, if the resource is an address, which computer application to execute from among a plurality of applications capable of being specified by the reference domain to contact the person corresponding to said address or to access the information corresponding to said address.

The card model used here makes it possible to define which application must be executed in response to the selection of that card by a user. Thus, this method for managing resources makes it possible to manage, with a single card model, addresses that may only be used by different computer applications. It therefore becomes possible to use a single resource manager to manage addresses as varied as shortcuts to webpages, access paths to video or audio files, a person's e-mail or postal addresses, people's telephone numbers, etc.

The embodiments of this method may comprise one or more of the following characteristics:
the reference domain specifies, in the event that the resource is an executable file, that the described resource is an executable file located in the location indicated by the access path;
the method comprises the creation of first and second new cards by instantiating the card model in order to describe, respectively, a first and second address, the respective reference domains of these first and second addresses specifying, respectively, first and second computer applications, the first computer application being incapable of contacting the person or accessing the information corresponding to the second address;
the instantiable model also makes it possible, when instantiated to create a new card, to freely define a name and a value of at least one tag;
the instantiable model also makes it possible, when instantiated to create a new card, to create a field intended to contain a link from the created card to another card in order to incorporate by reference the content of the other card into the created card whenever the created card is presented to a user;
the instantiable model also makes it possible, when instantiated to create a new card, to define a default reference domain whenever the created card contains multiple reference domains, the default reference domain specifying the computer application to be executed by default in response to the selection of that card by a user;
when a new card is created through the instantiation of the model, the reference domain may specify a computer application to execute chosen from the group comprising an application for making a telephone call, an application for sending an e-mail, an application for playing an audio or video file, an application for displaying an HTML page, and an application for displaying an RSS feed.

These embodiments of the management method further exhibit the following advantages:
having a card model which can also be used to describe executable files of a computer application makes it possible to easily adapt the management method to any type of resource,
having an instantiable model which enables the user to freely define the name and value of a tag, regardless of the resource described by the card, thereby makes it possible to define common search criteria so as to be able to select different types of resources that may be used by computer applications that are incompatible with one another,
having an instantiable model which makes it possible to incorporate by reference the content of other cards keeps information from being duplicated, which ultimately limits the size of the storage space needed to store the created cards,
having an instantiable model which makes it possible to define a default reference domain makes it possible to simplify the use of these cards.

Another object of the invention is an information recording medium containing instructions for executing the aforementioned resource management method whenever these instructions are executed by an electronic calculator.

Finally, another object of the invention is a resource management device comprising an electronic memory containing an instantiable model of a card intended to contain a description of a resource, this card model, during the instantiation thereof to create a new card, forcing the acquisition of:
a card identifier used to identify this card from among the set of all cards already created,
at least one access path containing the address in the event that the resource is an address and an access path in the event that the resource is an executable file, and
a reference domain for each access path, the reference domain specifying, if the resource is an address, which computer application to execute from among a plurality of applications capable of being specified by the reference domain to contact the person corresponding to said address or to access the information corresponding to said address.

The invention will be better understood upon reading the following description given only by way of a non-limiting example with reference to the drawings in which:

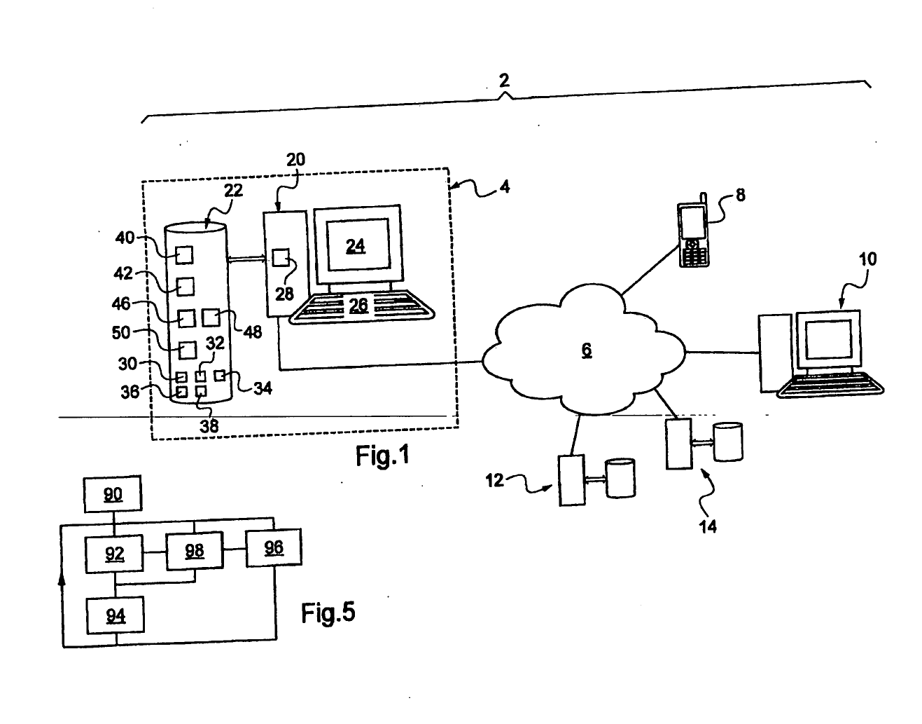

FIG. 1 is a schematic diagram of a telecommunications system incorporating a resource management device,

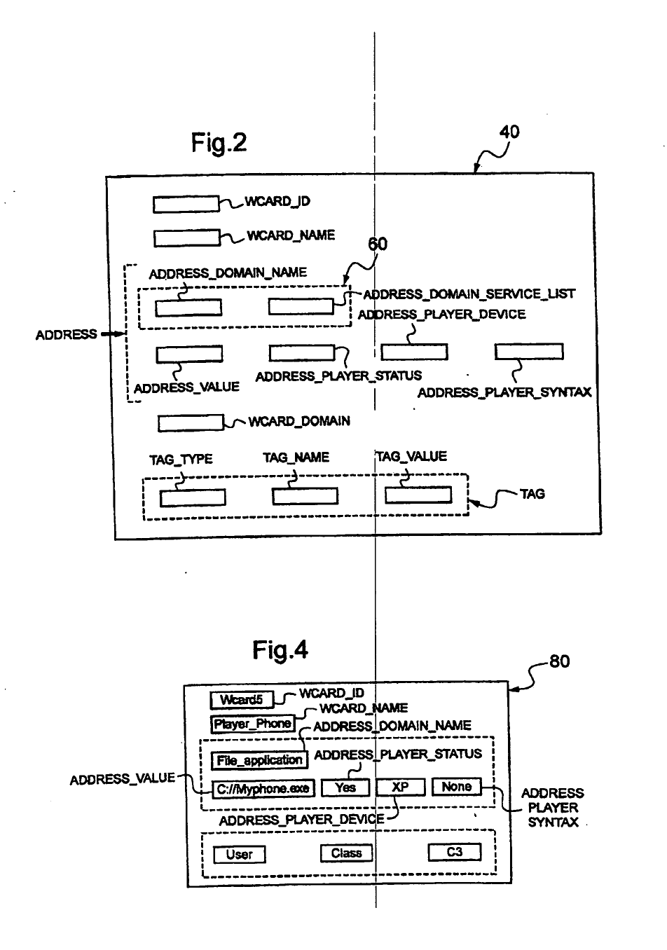

FIG. 2 is a schematic diagram of an instantiable model of a card used within the resource management device of FIG. 1,

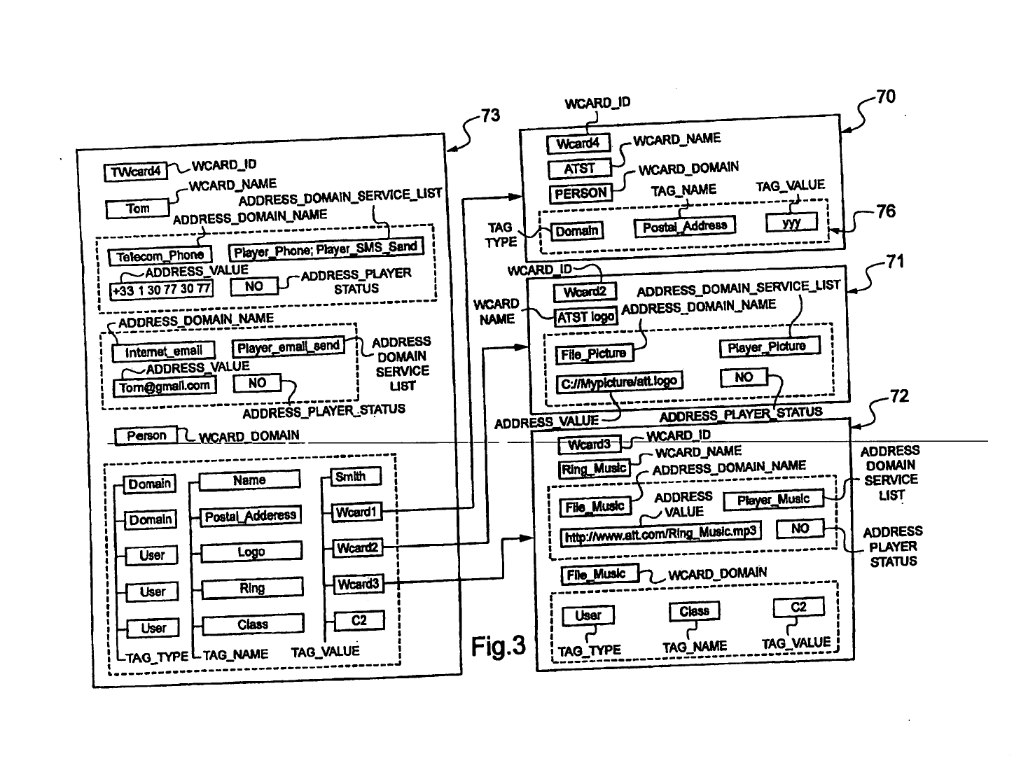

FIG. 3 is a depiction of multiple cards created by instantiating the model of FIG. 2;

FIG. 4 is a depiction of another card created by instantiating the model of FIG. 2; and

FIG. 5 is a flowchart of a resource management method using the device of FIG. 1.

FIG. 1 depicts a telecommunication system 2 enabling users to contact other users or access information. To that end, these users use communication terminals.

To simplify FIG. 1, only one communication terminal 4 has been depicted. The main characteristics of the other communication terminals may be deduced from the description that will be given of the terminal 4.

The terminal 4 makes it possible to contact other people by means of an information transmission network 6. For example, this network 6 comprises the Internet network.

Here, the terminal 4 is capable of establishing a telephone call with a telephone 8 or sending an e-mail to a computer workstation 10.

The terminal 4 is also capable of accessing various information such as audio files saved on a remote audio file server 12 and HTML pages saved on a remote Internet server 14.

The terminal 4 is constructed with the assistance of an electronic calculator capable of executing instructions saved on an information recording medium to implement the method of FIG. 5. In the particular situation described here, the terminal 4 is a computer equipped with a central processing unit 20 connected to an electronic memory 22. The central processing unit 20 is also connected to a human-machine interface comprising a monitor 24 and a keyboard 26.

For example, the central processing unit 20 comprises an electronic calculator 28 capable of executing the computer application instructions saved within the memory 22.

Here, the memory 22 comprises executable files corresponding to the following computer applications:
a telephone application 30 having a module for calling the telephone 8 and a module for sending an SMS (Short Message Service) message by means of the network 6,
an application 32 capable of sending e-mails to a recipient,
an Internet browser 34 capable of accessing information saved on Internet servers such as the server 14,
a computer application 36 having a module capable of playing music files, a module for playing video files, and a module for displaying images saved within a local memory or on a remote file server such as the server 12.

The memory 22 also comprises instructions 38 necessary to execute the method of FIG. 5. Thus, the combination of these instructions 38 and the calculator 28 forms a resource management device implemented within terminal 4.

Finally, the memory 22 also comprises the various information needed to execute the method of FIG. 5. In particular, the memory 22 comprises:
an instantiable card model 40,
a list 42 of tag names,
a list 46 of reference domain names,
   a list of 48 of default reference domain names, and
   an area 50 for storing information about the terminal 4 and about the users of the terminal 4.

FIG. 2 depicts an example of an instantiable card model 40. This model comprises:
a WCARD-ID field intended to contain a single identifier making it possible to identify the created card from among all of the other cards already created,
a WCARD-NAME field intended to contain the name of the card,
an ADDRESS section intended to contain the access path to the resource, as well as the reference domain associated with that resource,
a WCARD-DOMAIN field intended to indicate what the default reference domain is when the created card comprises multiple access paths, and
a TAG section intended to contain one or more tags.

Typically, the contents of the WCARD-ID field are automatically filled out when this model is instantiated.

The WCARD-NAME field may either be filled out manually by the user when a new card is created by instantiating that model, or automatically based on the content of the model's other fields.

The ADDRESS section is intended to contain one or more access paths. The access path is an address of a person to be contacted or of a piece of information to be accessed when the resource is an address. If the urce is an executable file, the access path corresponds to that executable file's access path. The value of the access path is saved in an ADDRESS-VALUE field. Each access path is associated with a reference domain 60. Here, the reference domain 60 is defined with the help of the ADDRESS-DOMAIN-NAME and ADDRESS-DOMAIN-SERVICE-LIST fields. The ADDRESS-DOMAIN-NAME field is designed to contain the name of the reference domain. When the model 40 is instantiated, this name may only be chosen from the list 46. For example, here, the list 46 comprises the following names:
“TELECOM-PHONE” to indicate that the access path is here a telephone number,
“INTERNET-E-MAIL” to indicate that the content of the access path is an e-mail address,
“INTERNET-WEB” to indicate that the access path is a URL (Uniform Resource Locator) of an HTML page,
“INTERNET-RSS” to indicate that the access path corresponds to an RSS (“Reach Site Summary” or “RDF Site Summary” or “Really Simple Syndication”) feed,
“FILE-MUSIC” to indicate that the access path is a path for accessing an audiophile,
“FILE-PICTURE” to indicate that the access path is the path for accessing a file containing a picture, and
“FILE-APPLICATION” to indicate that the access path is the path for accessing an executable file of a computer application.

The ADDRESS-DOMAIN-SERVICE-LIST field contains a list of computer applications that may use the content of the ADDRESS-VALUE field. Here, the content of the ADDRESS-DOMAIN-SERVICE-LIST field is a function of the conference of the ADDRESS-DOMAIN-NAME field. For example, the content of the ADDRESS-DOMAIN-SERVICE-LIST field is defined with the help of the following table:

| | Content of the |
|---|---|
| Content of the ADDRESS-DOMAIN- | corresponding ADDRESS- |
| NAME field | DOMAIN-SERVICE-LIST field |
| TELECOM-PHONE | PLAYER-PHONE, |
| | PLAYER-SMS-SEND |
| INTERNET-E-MAIL | PLAYER-E-MAIL-SEND |
| INTERNET-WEB | PLAYER-WEB |
| INTERNET-RSS | PLAYER-RSS |
| FILE MUSIC | PLAYER-MUSIC |
| FILE PICTURE | PLAYER-PICTURE |
| FILE VIDEO | PLAYER-VIDEO |

Thus, the reference domain 60 defines which computer application(s) must be executed in order to use the content of the ADDRESS-VALUE field. Whenever multiple applications are possible, a message is displayed so that the user himself can choose among the different applications that may be executed.

Here, the applications “PLAYER-PHONE” and “PLAYER-SMS-SEND” respectively correspond to the application's 30 modules capable of making a telephone call and sending an SMS. The application “PLAYER-E-MAIL-SEND” corresponds to the application 32. The application “PLAYER-WEB” corresponds to the application 34. The application “PLAYER-RSS” corresponds to particular module of the application 34 used to subscribe to and read RSS feeds. The applications “PLAYER-MUSIC”, “PLAYER-PICTURE” and “PLAYER-VIDEO” correspond to respective modules of the application 36.

Each access path is also associated with an ADDRESS-PLAYER-STATUT field. The content of this field makes it possible to discriminate between an access path to an executable file and an access path corresponding to an address. For example, this access path comprises the data “Y” when the access path is an access path to an executable file and the value “N” if not.

Whenever the access path is an access pa to an executable file, two additional fields ADDRESS-PLAYER-DEVICE and ADDRESS-PLAYER-SYNTAX must be completed. The ADDRESS-PLAYER-DEVICE field indicates the operating system(s) on which the executable file may be executed.

The ADDRESS-PLAYER-SYNTAX field describes the format of one or more parameters which must be transmitted to that application whenever it is executed. Typically, the parameter(s) in question are contained within a card's ADDRESS-VALUE fields.

The ADDRESS section may contain a description of one or more access paths. In the event that the ADDRESS section contains the description of multiple access paths, the WCARD-DOMAIN domain makes it possible to define which access path to use by default when the card created by instantiating the model 40 is selected by a user. Here, the content of that WCARD-DOMAIN field is, for example, chosen from a list 48. To simplify, here, this list 48 is identical to the list 46 except for the fact that it additionally comprises the “PERSON” value which makes it possible to indicate that the card describes a person's address. Here, the value “PERSON” indicates that the default application to use to reach this person is “PLAYER-PHONE”.

The TAG section is used to define one or more tags when the model 40 is instantiated. For example, these tags are intended to serve as criteria for searching for one or more created cards.

Here, each tag is defined using the following fields:
a TAG-TYPE field indicating the defined tag type,
a TAG-NAME field intended to contain the tag's name, and
a TAG-VALUE field intended to contain the tag's value.

Here, the model 40 is designed to require that the content of the TAG-TYPE field be chosen from a predetermined list. For example, this predetermined list contains the following three values “DOMAIN”, “SYSTEM”, and “USER”. Whenever the value of the TAG-TYPE field is “DOMAIN”, then the vale of the TAG-NAME field may only be chosen from the list 42. Here, the list 42 associates possible values for the TAG-NAME field based on the value contained with the WCARD-DOMAIN field. For example, if the value of the WCARD-DOMAIN field is “PERSON”, then the value of the TAG-NAME field must be chosen from the following list {“LAST NAME”, “FIRST NAME”, “DATE OF BIRTH”, etc.}.

If the WCARD-DOMAIN field contains the value “FILE-MUSIC”, then the content of the TAG-NAME field must be chosen from the following list {“TYPE OF ENCODING”, “TYPE OF FILE”, etc.}.

If the content of the TAG-TYPE field is “SYSTEM”, then it is a tag whose name and value are automatically determined by the resource management device. For example, it may be a tag for indicating when the last revision date of the created card's content was.

Finally, if the content of the TAG-TYPE field is “USER”, then the content of the TAG-NAME and TAG-VALUE fields may be freely chosen by the user when a card is creating through the instantiation of the model 40.

The card model 40 therefore requires the acquisition, when a card is created by instantiating that model, of a certain number of fields.

FIG. 3 depicts four examples of cards 70 to 73 created by instantiating the model 40. The card 70 describes a company whose name is “ATT”. The identifier of the card 70 is “WCARD1”. The card 70 has no ADDRESS section. On the other hand, the WCARD-DOMAIN field has been filled out with the value “PERSON”. The card 70 comprises a tag 76 used to define the mailing address of the company ATT. In the particular situation depicted in FIG. 3, a tag of the “DOMAIN” type has been used to define that company's mailing address.

The card 71 describes a picture. This card comprises a WCARD2 identifier and an “ATT logo” name as well as an access path to the file containing the picture to be displayed. The access path is contained within the ADDRESS-VALUE field. This access path is associated with a reference domain defined by the value of the ADDRESS-DOMAIN-NAME and ADDRESS-SERVICE-LIST fields. Here, this reference domain indicates that the application to be executed in order to display that picture is the “PLAYER-PICTURE” application.

The card 72 describes an audio file saved on a remote server such as the server 12. Here, this card has the identifier “WCARD3” and the name “RING-MUSIC”. This card also contains the access path to the audio file on the server 12 as well as a reference domain. Here, the reference domain specifies that the application to be executed to listen to this audio file is the application “PLAYER-MUSIC”.

Additionally, the user has freely defined a tag whose name is “CLASS” and whose value is “C2”. This tag is in some ways an annotation by the user intended to enable him to easily find the tag 72.

The tag 73 describes a person named “Tom”. Some people may be contacted by telephone or by e-mail. The card 73 therefore contains a first access path containing a telephone number and a second access path containing the e-mail address of that person. Each of these access paths is associated with a reference domain specifying which application to be executed in order to contact that person, either by telephone or by e-mail. More specifically, whenever the access path contains a telephone number, the reference domain specifies that the applications to be executed are “PLAYER-PHONE” and “PLAYER-SMS-SEND”. Given that two app cations may be executed, when the user seeks to contact that person by using his telephone number, a screen is displayed prompting the user to choose between these two applications that may be executed to contact this person using his telephone number.

For the e-mail address, the reference domain specifies that the application to be executed is “PLAYER-E-MAIL-SEND”.

Finally, the card 73 also comprises five tags. Two of these tags are used to define the family name and mailing address of that person. It should be noted that the value of the tag defining the mailing address is the “WCARD1” identifier from the card 70. Thus, in this specific situation, that person's mailing address is defined by reference to another card. In this situation, when information regarding that person is displayed, his or her address will be obtained from the content of the card 70.

The other defined tags are tags freely defined by the user. Here, the user has defined a tag whose name is “LOGO” and whose value comprises a reference to the card 71 such that the description of the logo contained within the card 71 does not need to be repeated within the card 73.

Another tag bears the name “RING”, and its value comprises a reference to the tag 72 so that it is not necessary to incorporate into the card 73 the full description of the audio file already included within the card 72.

Finally, the last tag defined by the user bears the name “CLASS”, meaning a name identical to that already used within the tag 72. Additionally, the value of that tag is also “C2” as within the tag 72. Thus, if the user searches for cards containing a tag whose name is “CLASS” and whose value is “C2”, he will find at least the tags 72 and 73. Thus, the user is able to select and manage cards describing resources of totally different types.

FIG. 4 depicts an example of a card 80 created by instantiating the model 40. This card 80 describes an executable application which may be located within a memory using the access path contained within the ADDRESS-VALUE field. In this situation, the reference domain indicates that it is an executable file. To that end, the ADDRESS-DOMAIN-NAME field contains the value “FILE-APPLICATION”. Additionally, the value of the ADDRESS-PLAYER-STATUT field equal to “Y”. Here, the ADDRESS-PLAYER-DEVICE field indicates that the operating system on which this application must be executed is the “Windows-XP”® operating system, and that no particular syntax is required for the parameter.

Here, the name of this card is “PLAYER-PHONE”. Thus, this card describes the application “PLAYER-PHONE” to be executed when the access path of a card contains a telephone number.

By way of an example, a tag freely defined by the user has been added to the content of the card 80. This tag bears the name “CLASS” and has the value “C3”.

The operation of the system 2 will now be described in greater detail with respect to the method of FIG. 5.

Initially, during a step 90, the model 40 is saved within the memory 22 along with the various applications and information needed to manage the cards. Next, during a step 92, the user creates cards by instantiating the model 40. When each card is created, the model 40 defines the information and format of the information that must be entered by the user.

Once multiple cards have been created, during a step 94, the user may select one of those cards. In response to the selection of a card describing an address for contacting a person or accessing a piece of information, the application specified by the reference domain is executed. The content of the ADDRESS-VALUE field is transmitted as a parameter to that specific application in order to automatically trigger the execution of a call or sending of an SMS message to the person to be contacted or in order to trigger the presentation of the information to be accessed. In the event that the selected card describes an executable file, the execution of this executable file is automatically triggered in response to that card's section.

In parallel with the steps of creating of selecting cards, the user may, for example, proceed with the following steps:
a step 96 of editing and/or deleting a card, and
   a step 98 of searching for one or more cards.

During the step 98, the cards are searched for using criteria specified by the user, such as the names and/or values of certain tags.

It is therefore understood that owing to the model 40, it is possible to manage any resources using a single application.

Many other embodiments are possible. For example, the terminal 4 may be a mobile telephone or a personal assistant such as a PDA (Personal Digital Assistant) or any other communication terminal.

The resources that may be described using the model 40 are not limited to the examples given in the preceding description. For example, video files, documents, or other files may also be described by a card obtained by instantiating the model 40.

Likewise, the various lists 42, 46, and 48 may be completed or modified as desired.

1. A resource management method, these resources being executable files stored within an electronic memory or addresses enabling a computer application to contact a person or to access a piece of information, characterized in that said method includes:
the saving (90), within a memory of an electronic calculator, of an instantiable model of a card intended to contain a description of a resource, said card model requiring, when it is instantiated to create a new card, the acquisition of:
a card identifier used to identify this card from among the set of all cards already created,
at least one access path (ADDRESS-VALUE) containing the address in the event that the resource is an address and an access path in the event that the resource is an executable file, and
a reference domain (60) for each access path, the reference domain specifying, if the resource is an address, which computer application to execute from among a plurality of applications capable of being specified by the reference domain to contact the person corresponding to said address or to access the information corresponding to said address.

2. A method according to claim 1, wherein the reference domain (60) specifies, in the event that the resource is an executable file, that the described resource is an executable file located in the location indicated by the access path.

3. A method according to any of the preceding claims, wherein the method comprises the creation (92) of first and second new cards by instantiating the card model in order to describe, respectively, a first and second address, the respective reference domains of these first and second addresses specifying, respectively, first and second computer applications, the first computer application being incapable of contacting the person or accessing the information corresponding to the second address.

4. A method according to any of the preceding claims, wherein the instantiable model also makes it possible, when instantiated to create a new card, to freely define a name and a value of at least one tag (TAG).

5. A method according to any of the preceding claims, wherein the instantiable model also makes it possible, when instantiated to create a new card, to create a field intended to contain a link from the created card to another card in order to incorporate by reference the content of the other card into the created card whenever the created card is presented to a user.

6. A method according to any of the preceding claims, wherein the instantiable model also makes it possible, when instantiated to create a new card, to define a default reference domain (WCARD-DOMAIN) whenever the created card contains multiple reference domains, the default reference domain specifying the computer application to be executed by default in response to the selection of that card by a user.

7. A method according to any of the preceding claims, wherein when a new card is created through the instantiation of the model, the reference domain may specify a computer application to execute chosen from the group comprising an application for making a telephone call, an application for sending an e-mail, an application for playing an audio or video file, an application for displaying an HTML page, and an application for displaying an RSS feed.

8. An information recording medium (22), characterized in that it comprises instructions for executing a management method according to any of the preceding claims, when these instructions are executed by an electronic calculator.

9. A resource management device, these resources being executable files stored within an electronic memory or addresses enabling a computer application to contact a person or to access a piece of information, characterized in that this device comprises an electronic memory (22) containing an instantiable model of a card intended to contain a description of a resource, this card model requiring, when it is instantiated to create a new card, the acquisition of:
a card identifier used to identify this card from among the set of all cards already created,
at least one access path (ADDRESS-VALUE) containing the address in the event that the resource is an address and an access path in the event that the resource is an executable file, and
a reference domain (60) for each access path, the reference domain specifying, if the resource is an address, which computer application to execute from a plurality of applications capable of being specified by the reference domain to contact the person corresponding to said address or to access the information corresponding to said address.
